(19) United States
(12) Patent Application Publication
(10) Pub. No.: US 2007/0143415 A1
(43) Pub. Date: Jun. 21, 2007

(54) Customizable presence icons for instant messaging

(76) Inventor: Brian K. Daigle, Marietta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/304,319

(22) Filed: Dec. 15, 2005

(51) Int. Cl. G06F 15/16

(52) U.S. Cl. 709/206

(57) ABSTRACT

Included are methods, for an instant messaging environment. One embodiment of the method include providing a first instant messaging user with an option to determine at least one instant messaging presence signifier; receiving a information related to at least one selected instant messaging presence signifier; and associating the at least one selected instant messaging presence signifier with at least one instant messaging presence status.

### BACKGROUND

With the advent of the Internet, different forms of digital communications have recently emerged. Examples of such digital communications include email and instant messaging (IM). Often, in instant messaging, one user communicates with another user in near real time. Unlike email messages, which reside on a server or a client device until deleted, instant messages generally vanish when an IM chat session is terminated, unless that instant messaging chat session is recorded in an instant messaging chat transcript.

Currently, techniques exist in instant messaging (IM) to provide a user with presence information related to a user's contacts. Generally speaking, the user manually designates the presence information displayed to contacts. If a user desires not to be reached, the user can designate that the “busy” presence information is conveyed to the user's contacts. Additionally, the user's instant messaging software can generally provide an “away” presence indication to a user's contacts when the user's machine has received no inputs after a predetermined time period. Further, if the user is not logged onto the instant messaging server, an “inactive” presence indication can be communicated to the user's contacts.

With these presence statuses, many instant messaging software applications incorporate predetermined presence icons. These icons are the same for indicating presence across all users. While this can be beneficial for providing information to a contact of the user, only limited information is generally conveyed to the contact. Additionally, depending on the settings of a particular user's instant messaging software, the user's presence that is displayed to a contact can be inaccurate and thus less valuable.

Thus, a heretofore unaddressed need exists in the industry to address the aforementioned deficiencies and inadequacies.

### SUMMARY

Included herein are methods for an instant messaging environment. Embodiments of the method include providing a first instant messaging user with an option to determine at least one instant messaging presence signifier, wherein the at least one instant messaging presence signifier is configured to provide information related to an instant messaging presence status of the first instant messaging user. Embodiments of the method also include receiving information related to at least one selected instant messaging presence signifier, where the at least one selected instant messaging presence signifier is selected for conveying, to a second instant messaging user, an instant messaging presence status. Further, embodiments of the method also include associating the at least one selected instant messaging presence signifier with at least one instant messaging presence status.

Also included herein are embodiments of a computer readable medium that includes a program for an instant messaging environment. Embodiments of the computer readable medium include logic configured to provide a first instant messaging user with an option to determine at least one instant messaging presence signifier and logic configured to receive a information related to at least one selected instant messaging presence signifier. Embodiments of the computer readable medium also include logic configured to associate the at least one selected instant messaging presence signifier with at least one instant messaging presence status.

Other systems, methods, features, and advantages of this disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

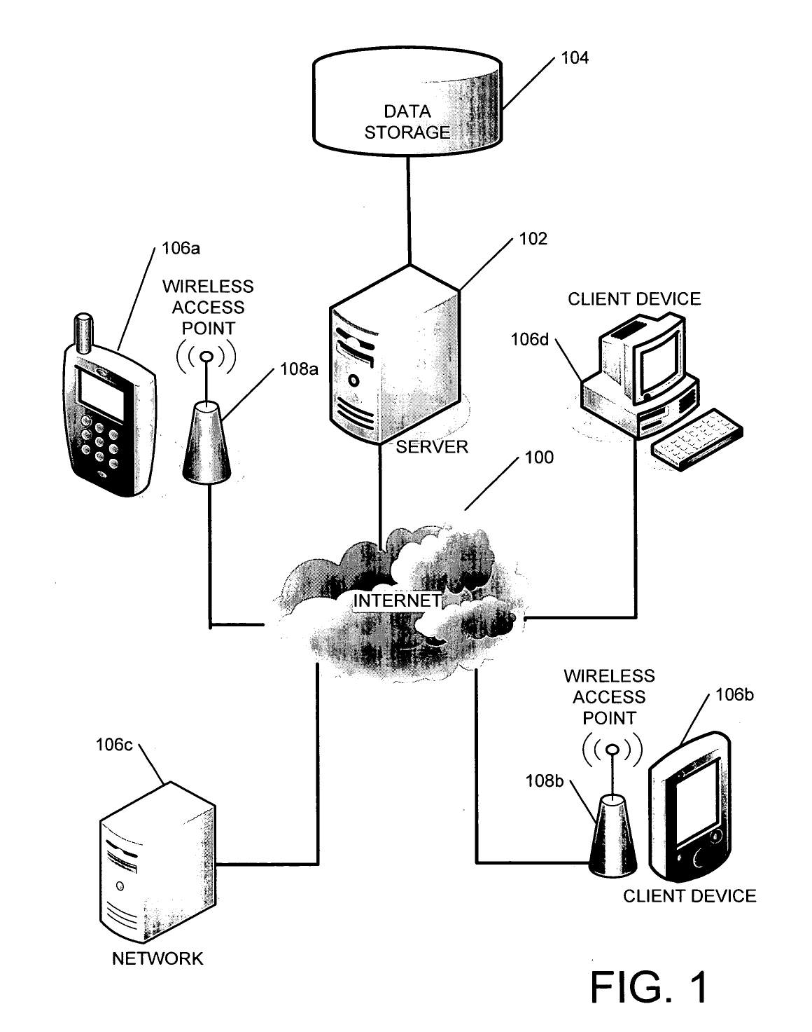

FIG. 1 is a functional diagram of an exemplary instant messaging network environment.

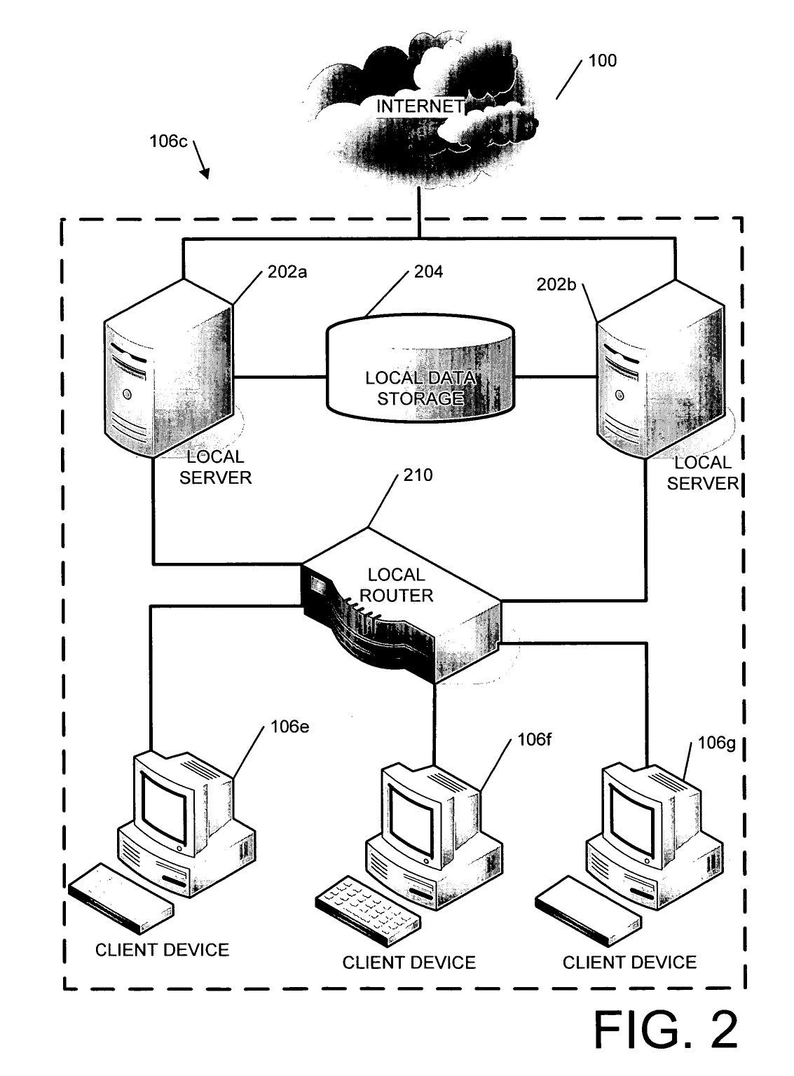

FIG. 2 is a functional diagram of an exemplary local network environment by which a user can send an instant message, similar to the environment from FIG. 1.

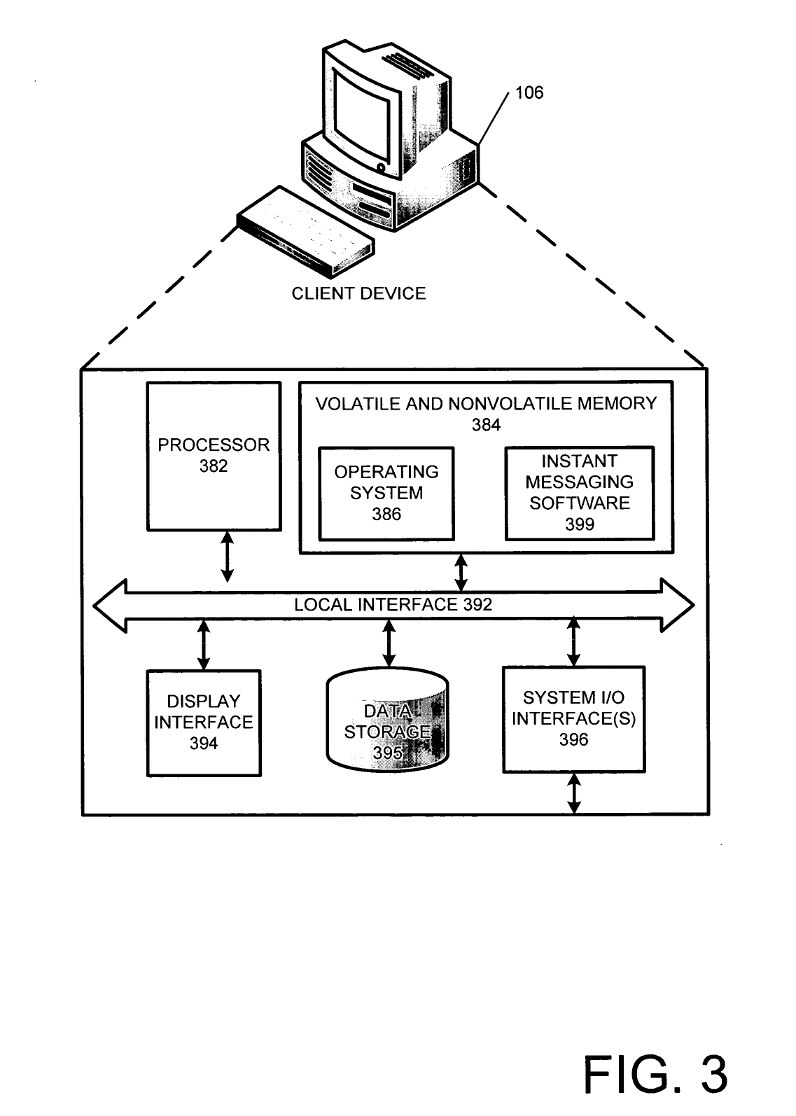

FIG. 3 is a functional diagram illustrating an exemplary embodiment of a client device that may be configured to communicate via a communications network, such as the networks from FIGS. 1 and 2.

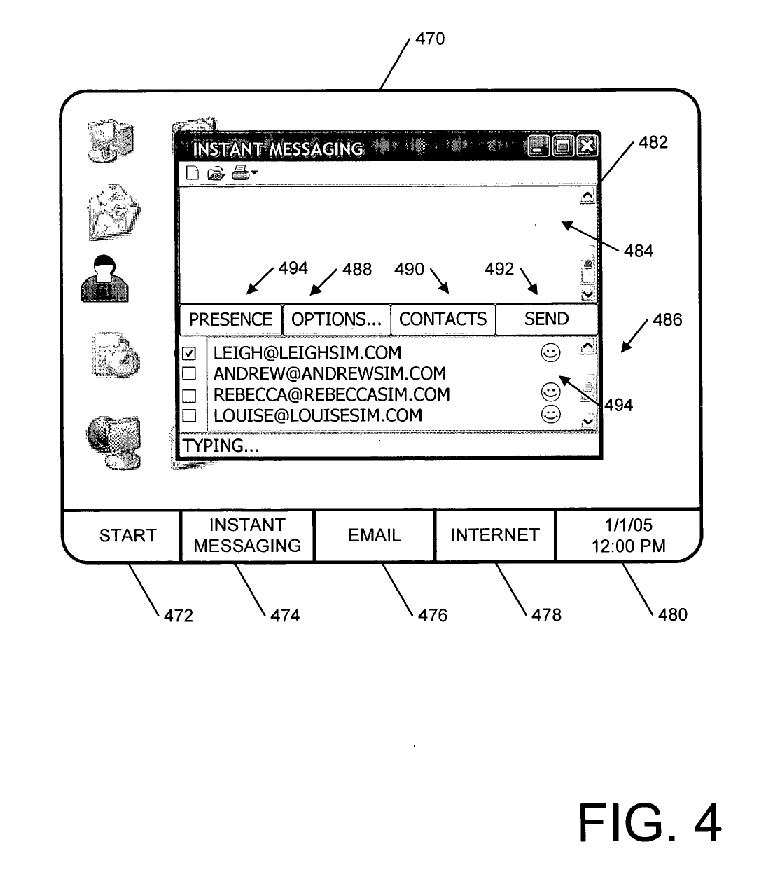

FIG. 4 is an exemplary display of a first user's instant messaging window, pursuant to the instant messaging software illustrated in FIG. 3.

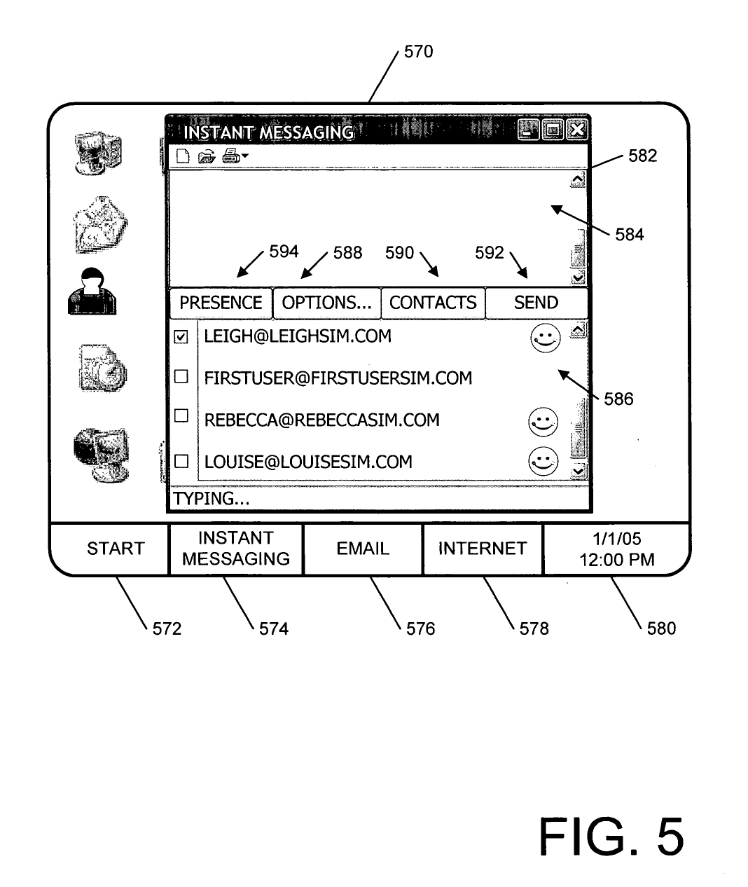

FIG. 5 is an exemplary display of a second user's instant messaging window, pursuant to the instant messaging software illustrated in FIG. 3.

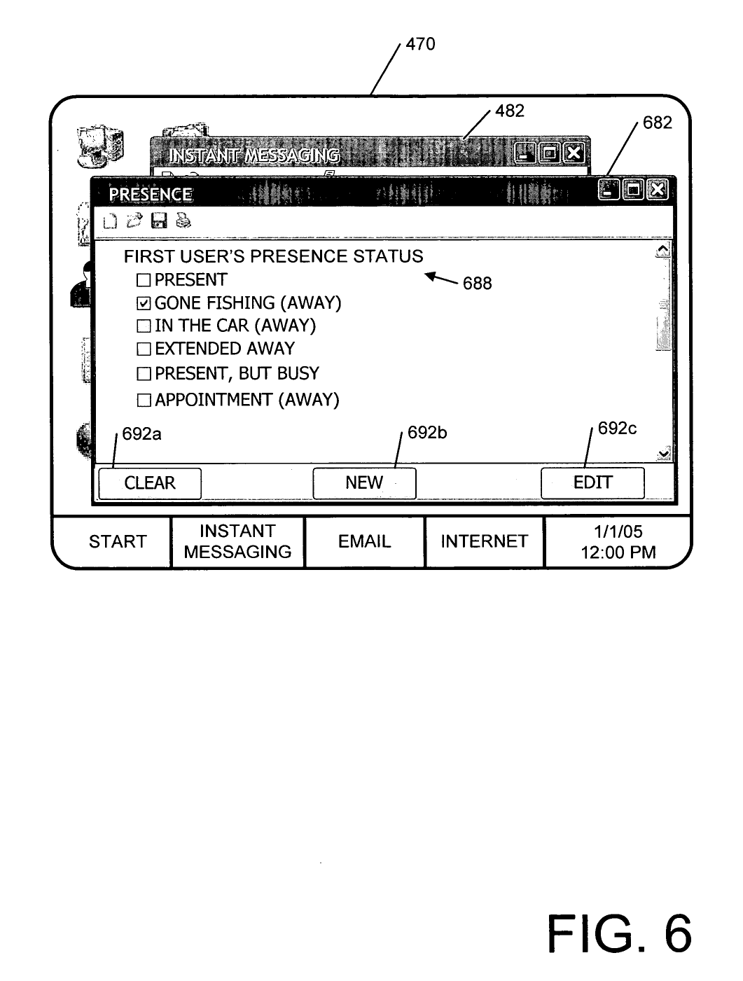

FIG. 6 is an exemplary presence window for a first user's instant messaging software, as illustrated in FIG. 3.

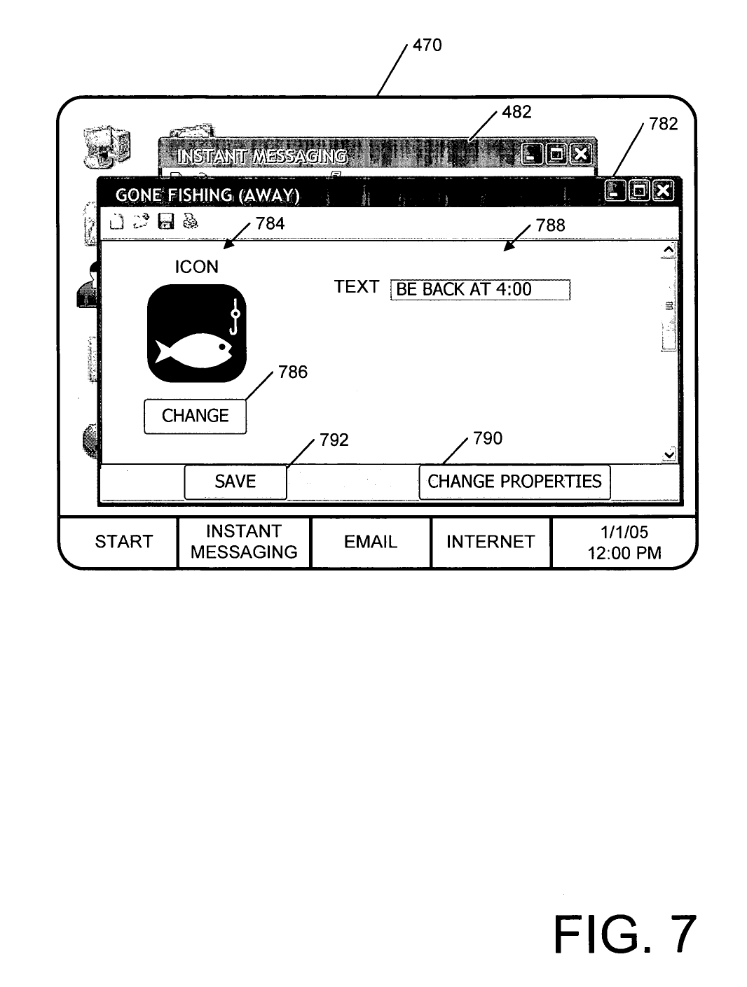

FIG. 7 is an exemplary specific presence window for a first user's instant messaging software, as illustrated in FIG. 3.

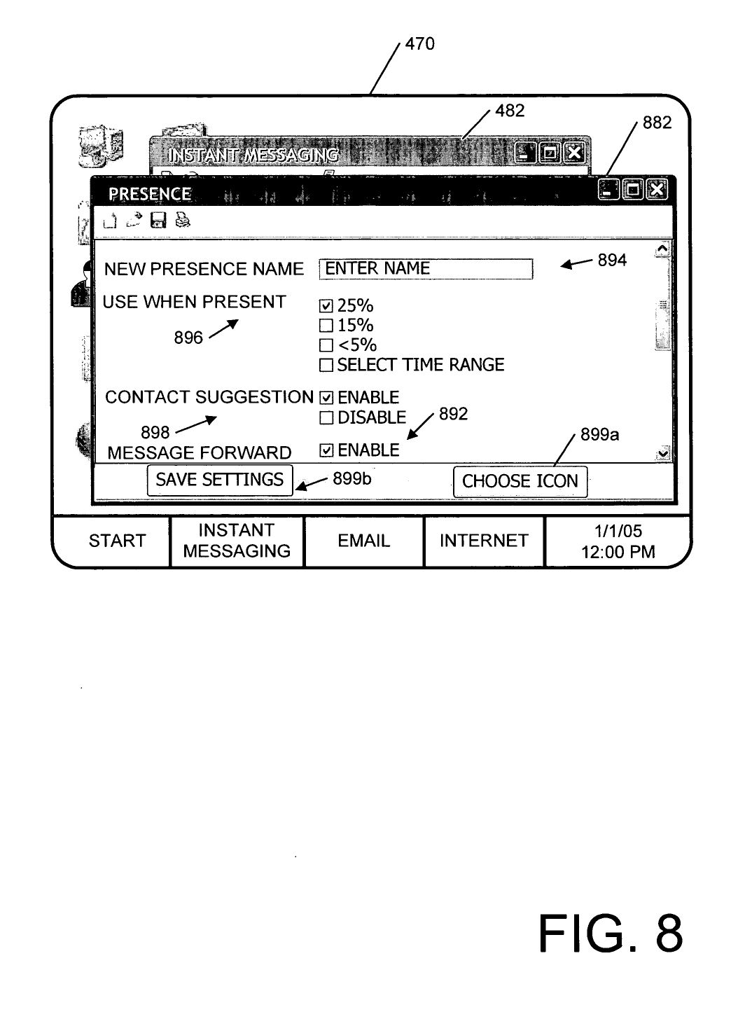

FIG. 8 is an exemplary presence settings window for a first user's instant messaging software, as illustrated in FIG. 3.

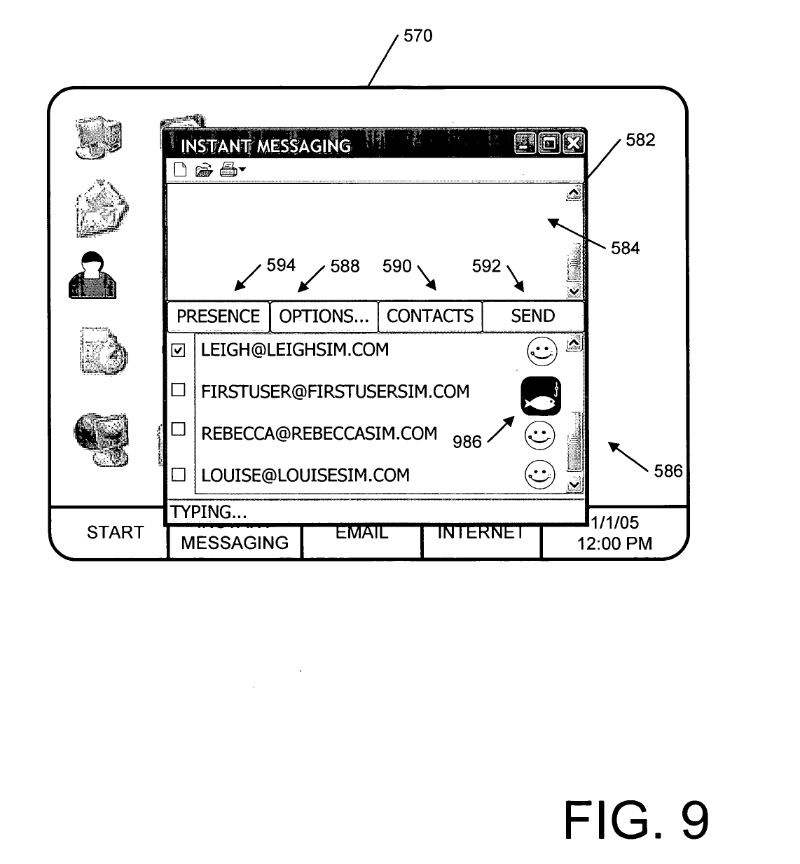

FIG. 9 is an exemplary display of a second user's instant messaging window with a customizable presence icon, pursuant to FIG. 7.

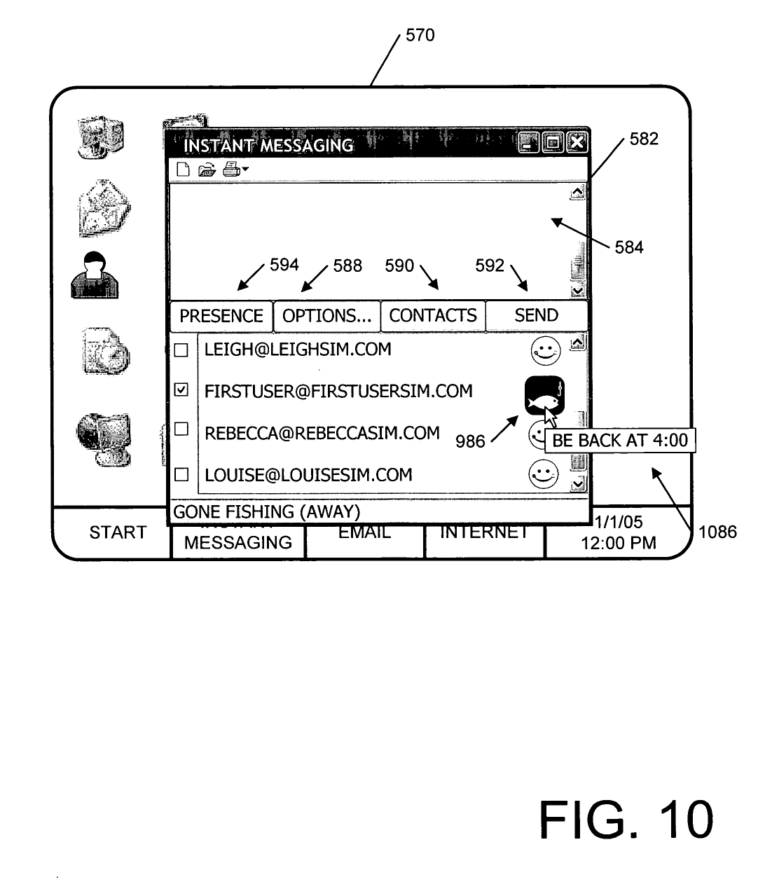

FIG. 10 is an exemplary display of a second user's instant messaging window with a user's customizable presence icon, pursuant to FIG. 7.

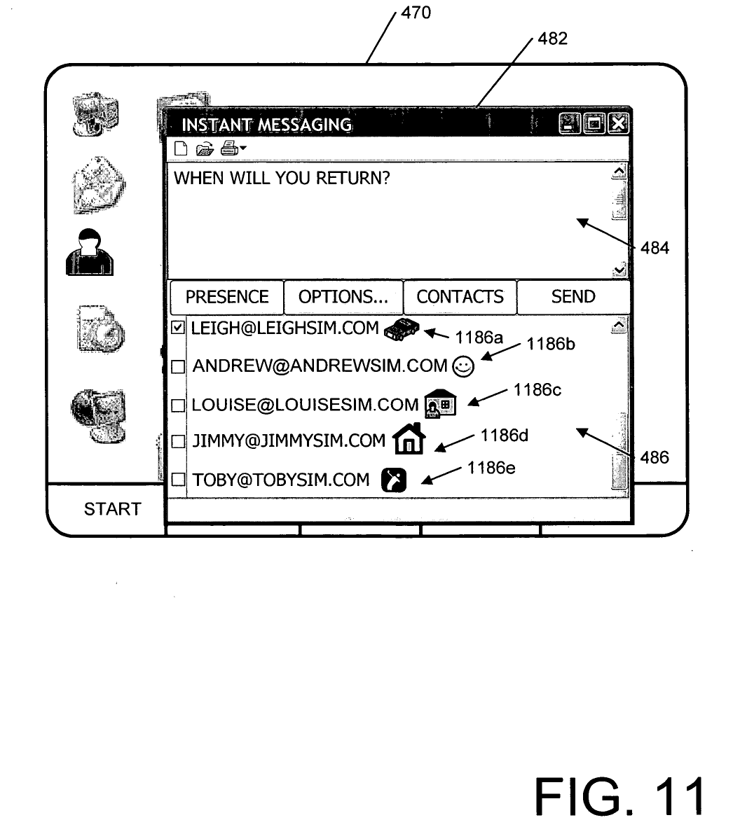

FIG. 11 is an exemplary display of a first user's instant messaging window illustrating a plurality of customizable presence icons, similar to the presence icon from FIG. 10.

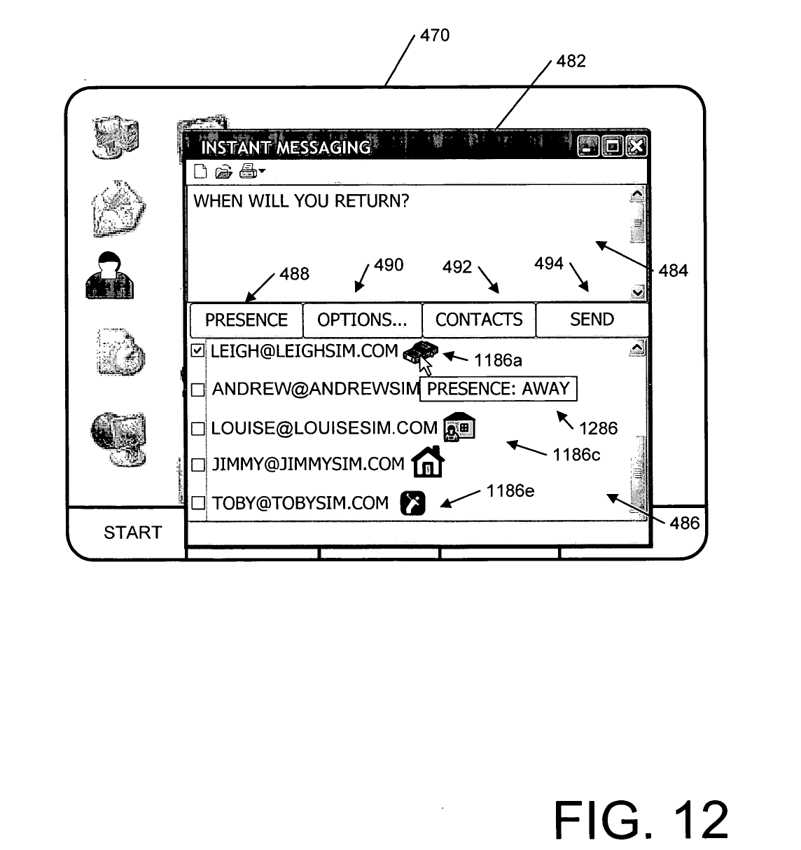

FIG. 12 is an exemplary display of customizable presence icons and customizable text that can be displayed for the icons from FIG. 11.

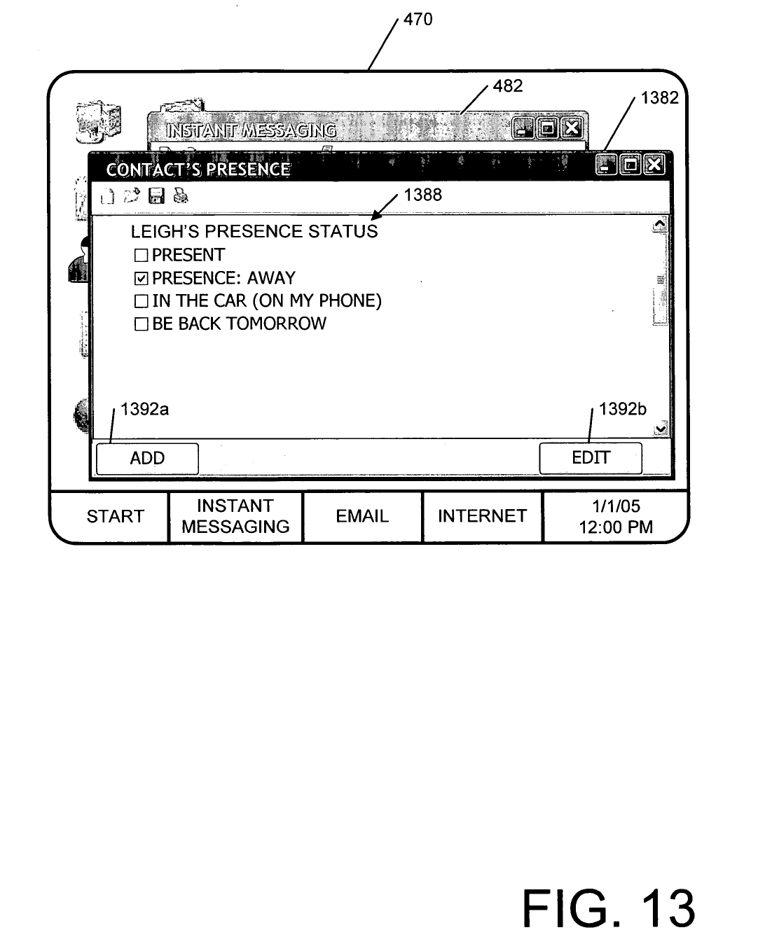

FIG. 13 is an exemplary display of a presence window for viewing a second user's presence status options, similar to the display from FIG. 6.

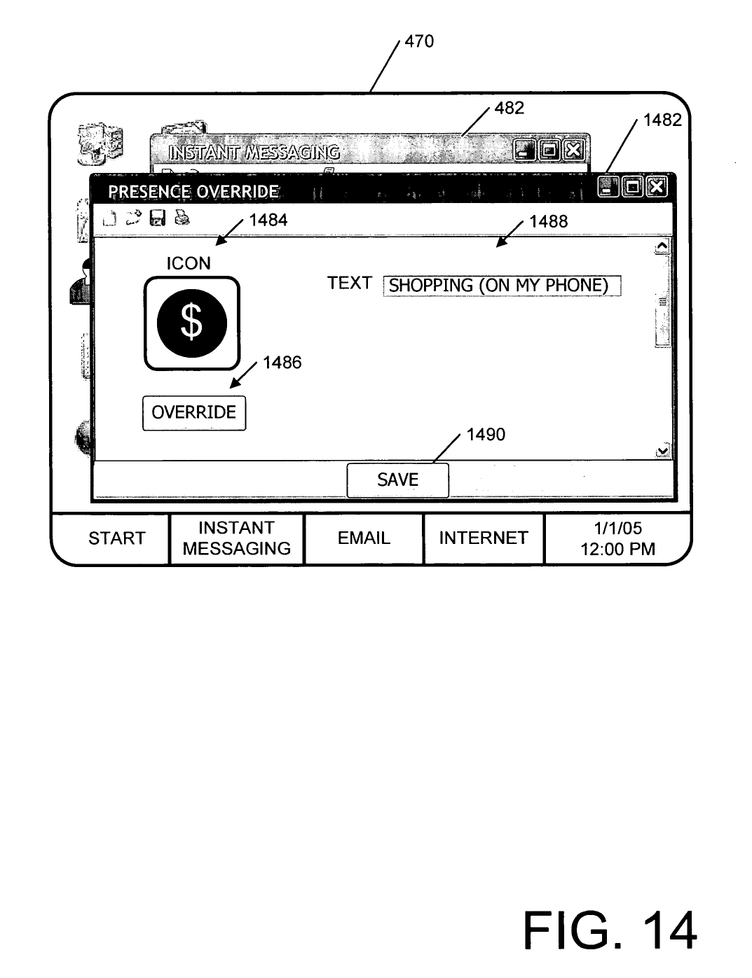

FIG. 14 is an exemplary override window for overriding the customizable presence icon, such as the icons from FIG. 11.

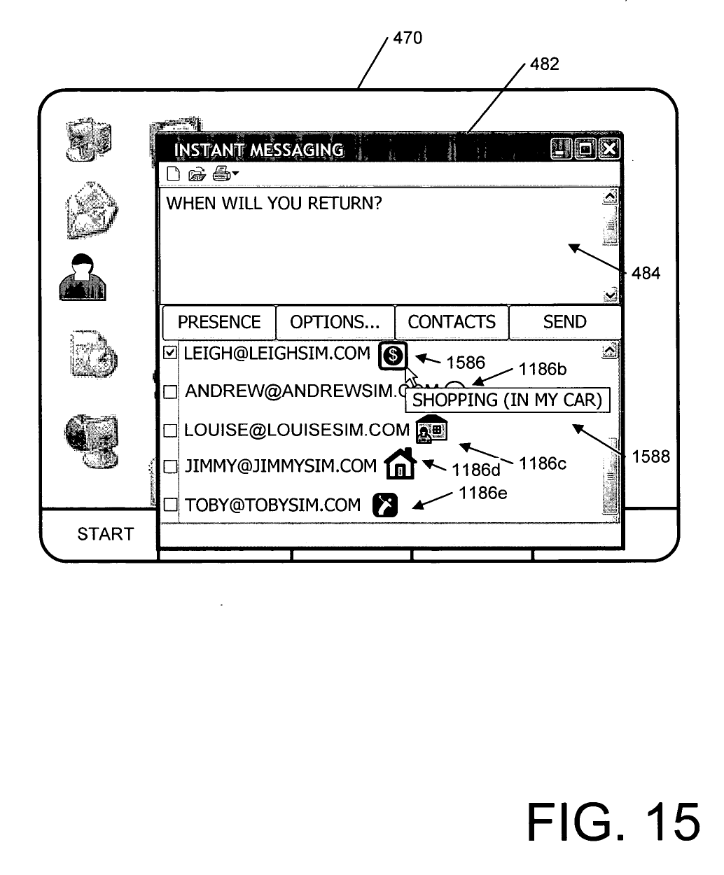

FIG. 15 is an exemplary display of a first user's instant messaging window illustrating use of the icon from FIG. 14.

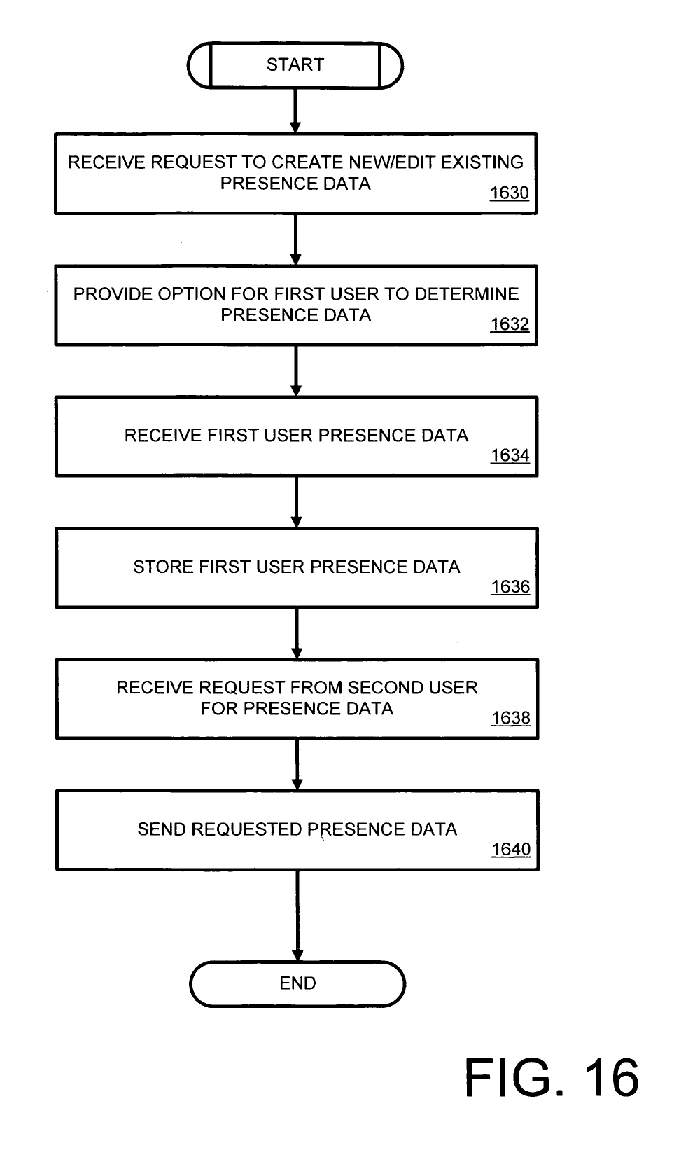

FIG. 16 is a flowchart illustrating exemplary steps that can be taken by instant messaging software for using customizable presence icons, such as the icons from FIG. 11.

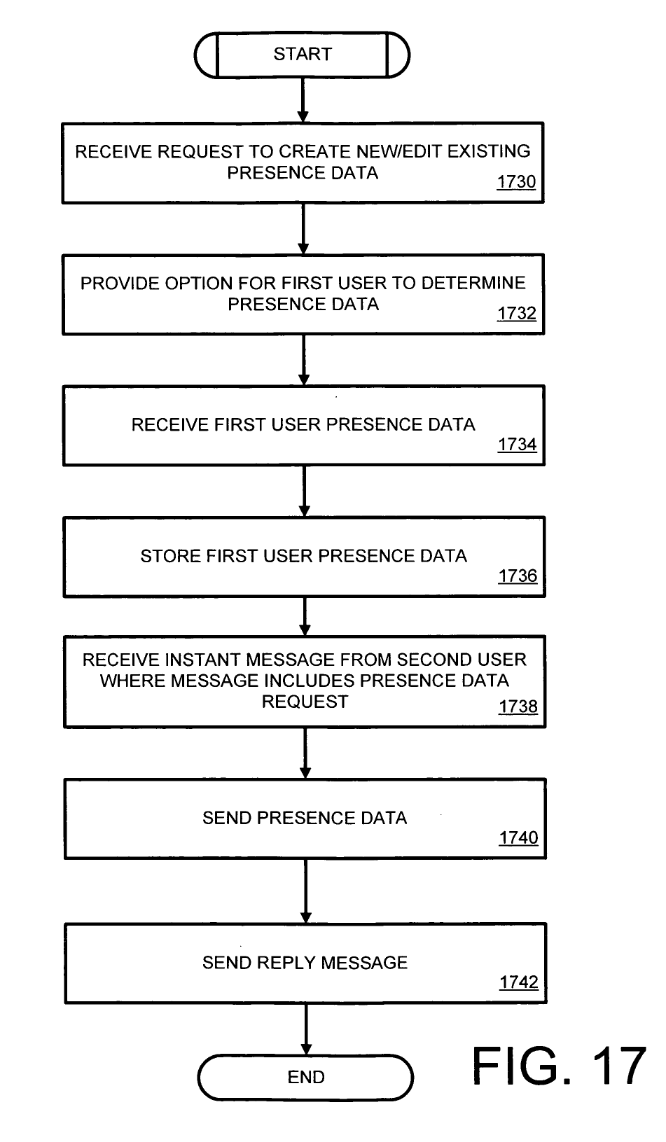

FIG. 17 is a flowchart illustrating exemplary steps that can be taken by a first user's instant messaging software for sending, customizable presence icons, such as the icons from FIG. 11.

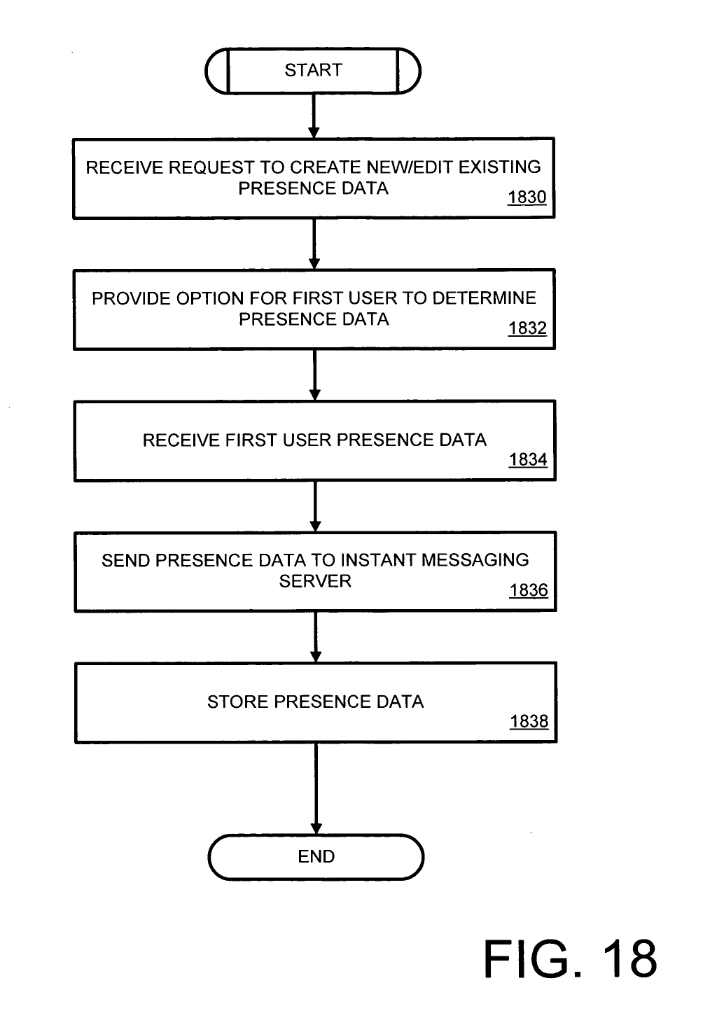

FIG. 18 is a flowchart illustrating exemplary steps that can be taken by instant messaging software for sending customizable presence data to a server, such as the server from FIG. 1.

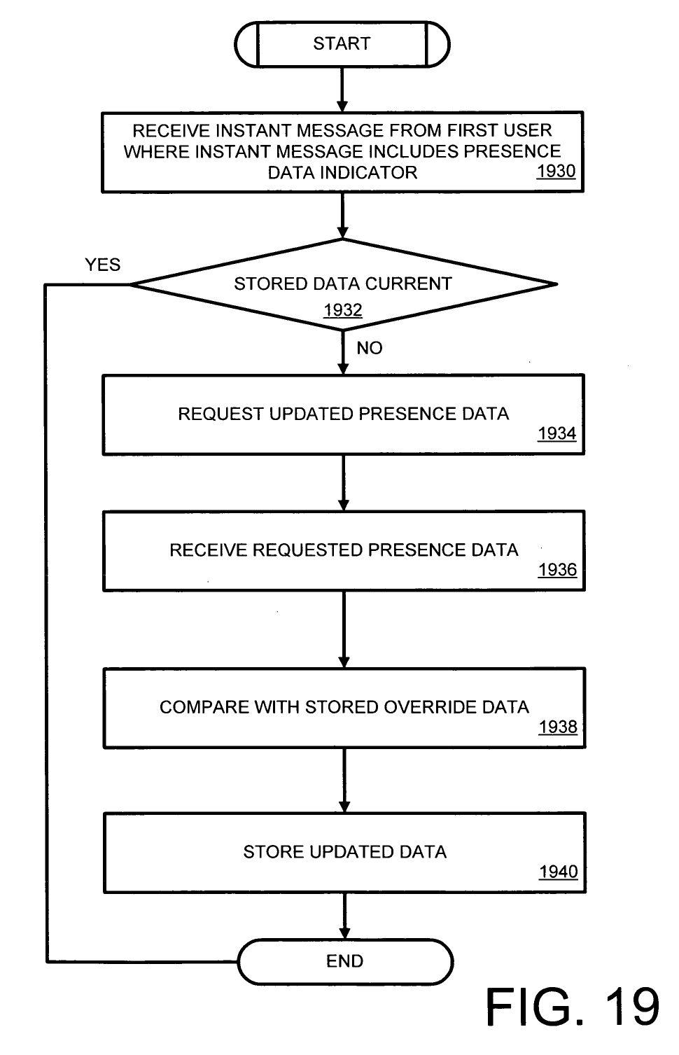

FIG. 19 is a flowchart illustrating exemplary steps that can be taken by instant messaging software for determining and updating customizable presence data, such as the icons from FIG. 5.

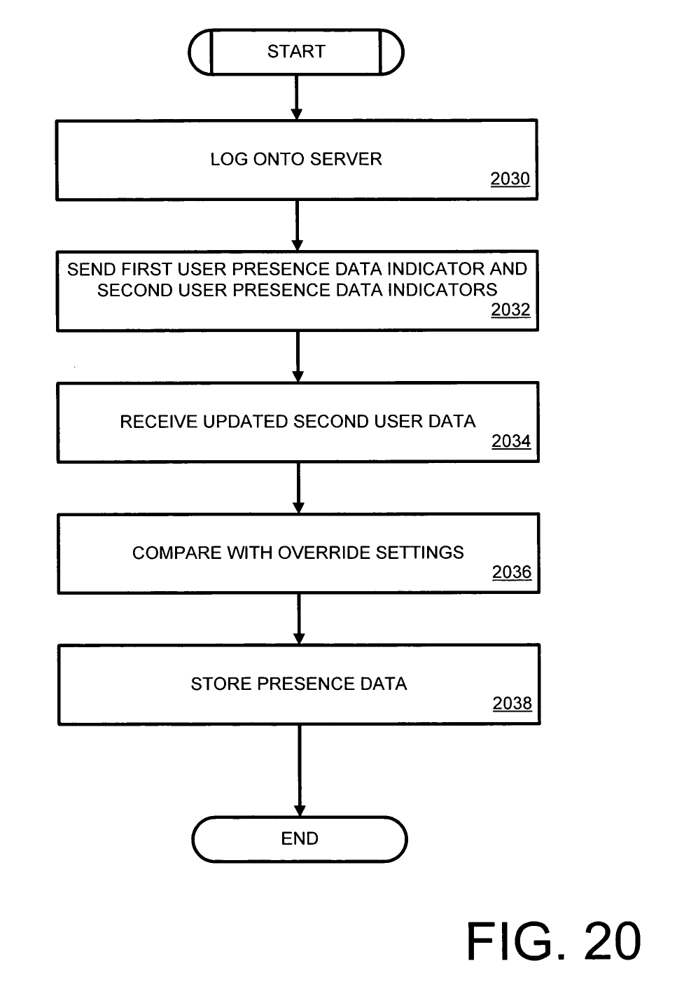

FIG. 20 is a flowchart illustrating exemplary steps that can be taken by instant messaging software in utilizing customizable presence icons, such as the icons from FIG. 5.

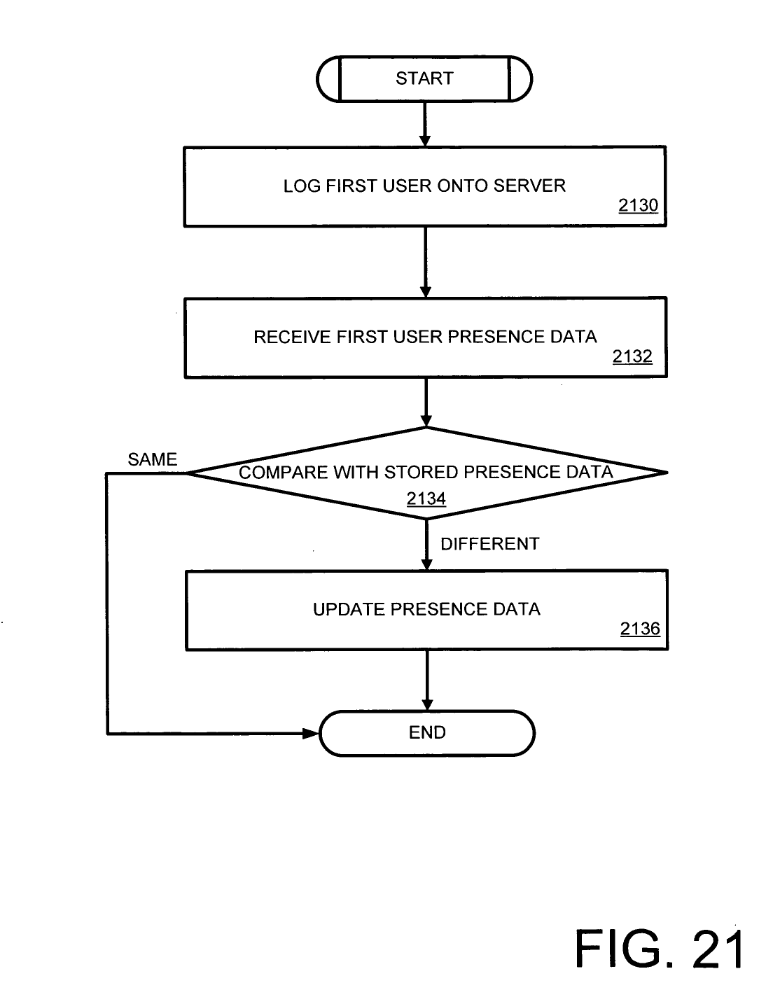

FIG. 21 is a flowchart illustrating exemplary steps that can be taken by a server in utilizing customizable presence icons, such as the icons from FIG. 5.

### DETAILED DESCRIPTION

FIG. 1 is a functional diagram of an exemplary instant messaging network environment. As illustrated, a plurality of users may be connected via an external network such as Internet 100 or other communications network. The users may access the Internet 100 via client devices 106a (via wireless access point 108a), 106b (via wireless access point 108b), 106c, and 106d. The client devices may include, for example, portable communication devices 106a and 106b, a local network 106c and/or a personal computer 106d. It should be appreciated that the external network, client devices and connections illustrated in FIG. 1 are shown by way of example, but this disclosure is not limited to these examples. The disclosure may be applicable to any client device, connection, and external network that supports instant messaging. Additionally included in this nonlimiting example is a server 102 that is coupled to a data storage unit 104.

During an instant messaging session, a user may activate instant messaging client software that is stored on the user's client device 106a. Activation of the instant messaging client software can facilitate a connection request with the server 102, which may be a dedicated instant messaging server. The server 102 can then authenticate the user via any of a number of authentication techniques including, but not limited to technologies related to a user identification (userid) and password (userpw) and various biometric authentication processes. According to an exemplary embodiment, the authentication process includes the server receiving data (such as a userid and userpw) and comparing that data with data stored on data storage 104 (data storage logic, database, or authentication server). If the data submitted by the user matches the data stored in data storage 104, the user can be authenticated, and granted access to instant messaging services.

Once the user has been authenticated, the user can send an instant message to any of his or her contacts (e.g., persons to whom the user communicates). According to an exemplary embodiment, the user can send an instant message to anyone who has an account with the server 102. If the user knows the desired recipient's account name, handle, or instant message identification (IMID) associated with the server 102, the user can send an instant message to that recipient. In many circumstances, the user will have the user's contacts saved on instant messaging client software or on the server 102 such that the user does not have to re-enter the account name each time the user wishes to send an instant message.

Additionally, the server 102 can keep track of the various users that are currently logged onto the server, and provide presence information regarding the user's contacts. Thus, if a user wishes to send an instant message to a recipient, the server 102 can send information as to whether that contact is currently logged onto the server. Upon receiving presence data related to the user's contacts, the user can then send an instant message to a recipient (whose presence is known), thereby beginning an instant messaging chat session. While the server 102 can monitor presence data for each user associated with the server 102, other implementations can provide that logic on user device 106 determines the user's presence. The user's client device 106 can then communicate this data to the server 102 for transmission to other users.

In at least one instant messaging environment, each message sent between the user and the contact can be communicated through the server 102. In such a scenario, the user at client device 106a can compose and send an instant message that is directed from the user's client device 106a to the wireless access point 108a, and then to the Internet 100. The message can then be sent to the server 102 back through the Internet 100 to the recipient's client device 106b. Other embodiments can provide that the server 102 initiate a communication between users, however once the communication is established, the server 102 can be removed from the communication such that the users can communicate directly.

Additionally, while some instant messaging environments have a dedicated instant messaging server (or servers), others may use general purpose devices of varying capabilities to manage instant messaging traffic as well as perform other tasks. Further, while this nonlimiting example discusses a proprietary instant messaging environment, one should note that this disclosure also contemplates an environment utilizing a universal instant messaging protocol, or a communications environment that facilitates communication across a plurality of different instant messaging services using a plurality of different instant messaging protocols.

FIG. 2 is a functional diagram of an exemplary local network environment by which a user can send an instant message, similar to the environment from FIG. 1. The local network environment of FIG. 2 can be a home network, a business network or other network configured to facilitate communication between users. As illustrated, client devices 106e, 106f, 106g are coupled to a local router 210. This coupling may be wire-line or wireless. Though depicted as personal computers, the client devices 106e, 106f, and 106g may be implemented with any device capable of supporting instant messaging in a local network. The local router 210 is coupled to local server 202a and local server 202b. The local servers 202a, 202b (collectively referred to as local server 202) are coupled to local data storage 204. Though two local servers are shonw in FIG. 2 for ease of illustration, it will be appreciated that more or fewer than two local servers may be used. The local servers 202 are also coupled to an external network, such as the Internet 100.

In this exemplary networking environment a user located at client device 106e may desire to send an instant message to a recipient located at client device 106g. In the networking environment of FIG. 2, the user at client device 106e can compose and send the instant message via client software stored on the client device 106e. The message can then be sent from the client device 106e to the local router 210. The local router can then send the message to one of the local servers 202. The local server 202 can communicate the message back through the local router 210 to the intended recipient located at client device 106g.

As the nonlimiting example of FIG. 2 illustrates, in some embodiments instant messages can be sent internal to the local network 106c, without the user of an external network, such as the Internet 100. As stated above, such a configuration may be desirable for a business that wishes to facilitate communication between employees, but not to the Internet community at large. Such a configuration may use its own instant messaging protocol, a universal instant messaging protocol, or a proprietary instant messaging protocol.

Additionally, while the configuration of FIG. 2 facilitates intra-network instant messaging, this configuration can also facilitate inter-network instant messaging, similar to the configuration from FIG. 1. In such a scenario, a user operating client device 106f can send and receive messages to a contact that is not located within the local network of FIG. 2. The message can be sent through local router 210 to local server 202. From local server 202, the message can be sent to an external network, such as the Internet 100.

Referring back to FIG. 1, the message can then be sent from the network 106c to server 102 (which is not part of the local network in FIG. 2), and then back through the Internet 100 to client device 106b. The contact that is operating client device 106b can then reply through the same channels. More specifically, the reply message can be sent from 106b through the Internet 100 to the server 102, back through the Internet 100, to the network 106c (to FIG. 2), to the local server 202, through the local router 210, and back to the user at client device 106f.

One should note that the configuration of FIG. 2 is a nonlimiting example. Components can be added or removed (or both) without diverging from the scope of this disclosure. Additionally, although the configurations from FIGS. 1 and 2 are illustrated as various examples of instant messaging configuration, these are not meant to be limiting. More specifically, in at least one configuration, instant messages sent between unrelated users need not use the Internet 100. Two users that are engaged in an instant messaging chat session on the same Internet Service Provider (ISP) may not require the use of the Internet 100 to facilitate the communication. As the ISP can link a user to the Internet 100, two users operating on the same ISP may simply use the ISP to facilitate the communication. In such a scenario, the configuration of FIG. 2 becomes more applicable, even for users who are not otherwise related. Additionally, if a company has multiple offices, use of the Internet 100 for instant messaging communications may be desired, and may be implemented similar to the configuration of FIG. 1.

FIG. 3 is a functional diagram illustrating an exemplary embodiment of a client device that may be configured to communicate via a communications network such as the networks from FIGS. 1 and 2. Although a wire-line client device is illustrated, this discussion can be applied to any device. According to an exemplary embodiment, in terms of hardware architecture, as shown in FIG. 3, the client device 106 includes a processor 382, volatile and nonvolatile memory 384, a display interface 394, data storage 395, and one or more input and/or output (I/O) device interface(s) 396 that are communicatively coupled via a local interface 392. The local interface 392 can include, for example but not limited to, one or more buses or other wired or wireless connections. The local interface 392 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 382 may be a hardware device for executing software, particularly software stored in volatile and nonvolatile memory 384.

The processor 382 can be any custom made or commercially available processor, a central processing unit (CPU), an auxiliary processor among several processors associated with the client device 106, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard® Company, an 80x86 or Pentium® series microprocessor from Intel® Corporation, a PowerPC® microprocessor from IBM®, a Sparc® microprocessor from Sun Microsystems®, Inc, or a 68xxx series microprocessor from Motorola® Corporation.

The volatile and nonvolatile memory 384 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 384 may incorporate electronic, magnetic, optical, and/or other types of storage media. Note that the volatile and nonvolatile memory 384 can have a distributed architecture, where various components are situated remote from one another, but can be accessed by the processor 382.

The software in volatile and nonvolatile memory 384 may include one or more separate programs, each of which includes an ordered listing of executable instructions for implementing logical functions. In the example of FIG. 3, the software in the volatile and nonvolatile memory 384 may include instant messaging software 399, as well as an operating system 386. A nonexhaustive list of examples of suitable commercially available operating systems is as follows: (a) a Windows® operating system available from Microsoft® Corporation; (b) a Netware® operating system available from Novell®, Inc.; (c) a Macintosh® operating system available from Apple® Computer, Inc.; (d) a UNIX operating system, which is available for purchase from many vendors, such as the Hewlett-Packard® Company, Sun Microsystems®, Inc., and AT&T® Corporation; (e) a LINUX operating system, which is freeware that is readily available on the Internet 100; (f) a run time Vxworks® operating system from WindRiver® Systems, Inc.; or (g) an appliance-based operating system, such as that implemented in handheld computers or personal data assistants (PDAs) (e.g., PalmOS® available from Palm® Computing, Inc., and Windows CE® available from Microsoft® Corporation). The operating system 386 essentially controls the execution of other computer programs and provides scheduling, input-output control, file and data management, memory management, and communication control and related services.

A system component embodied as software may also be construed as a source program, executable program (object code), script, or any other entity comprising a set of instructions to be performed. When constructed as a source program, the program is translated via a compiler, assembler, interpreter, or the like, which may or may not be included within the volatile and nonvolatile memory 384, so as to operate properly in connection with the Operating System 386.

The Input/Output devices that may be coupled to system I/O Interface(s) 396 may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

If the client device 106 is a personal computer, workstation, or the like, the software in the volatile and nonvolatile memory 384 may further include a basic input output system (BIOS) (omitted for simplicity). The BIOS is a set of software routines that initialize and test hardware at startup, start the Operating System 386, and support the transfer of data among the hardware devices. The BIOS is stored in ROM so that the BIOS can be executed when the client device 106 is activated.

When the client device 106 is in operation, the processor 382 is configured to execute software stored within the volatile and nonvolatile memory 384, to communicate data to and from the volatile and nonvolatile memory 384, and to generally control operations of the client device 106 pursuant to the software. Software in memory, in whole or in part, is read by the processor 382, perhaps buffered within the processor 382, and then executed.

FIG. 4 is an exemplary display of a first user's instant messaging window, pursuant to the instant messaging software illustrated in FIG. 3. As illustrated, the desktop display 470 can include a “START” option 472, an “INSTANT MESSAGING” taskbar menu item 474, an “EMAIL” taskbar menu item 476, an “INTERNET” taskbar menu item 478, and a Date and Time indicator 480. As one of ordinary skill in the art will understand, the taskbar menu items can be linked to various software programs that are currently open on the client device 106. As a nonlimiting example, the instant messaging software 399, which is facilitating display of instant messaging window 482, relates to the taskbar menu item 474. By selecting the “INSTANT MESSAGING” taskbar menu item 474, the first user can display and remove the instant messaging window 482 from the desktop display 470.

As also illustrated, the instant messaging window 482 includes a text prompt 484 for the first user to enter a message. The input box 484 can be configured to display both outgoing messages and incoming messages. As such, a history (thread) of the current instant messaging session can be documented. A contact can be chosen by selecting the checkbox next to the desired contact (or contacts) in the contact section 486 of the instant messaging window 482. Additionally in contact section 486 is a presence icon associated with each contact that is present (logged onto the instant messaging server 102). As discussed above, the server 102 can determine which users are currently logged onto the server and can display this information to contacts of that user. In this nonlimiting example, the contacts “Leigh,” “Rebecca,” and “Louise” are currently logged onto the server, while “Andrew” is not logged onto the server. While the presence icons for “present” and “not present” can provide information to the user, this information is limited to the icons and the presence statuses available.

Additionally included in the instant messaging window 482 are a “PRESENCE” option 494, an “OPTIONS . . . ” option 488, a “LOGS . . . ” option 490, and a “SEND” option 492. The “PRESENCE” option 494 can provide the first user with the ability to determine presence settings, as discussed in more detail below. The “OPTIONS . . . ” option 488 can provide the user access to various options related to the display of the instant messaging Window 482, sending options, receiving options, etc. The “CONTACTS” option 490, on the other hand can provide the first user with data related to the first user's contacts and the contacts' presence. The “SEND” option 492 is an action option that executes sending of a message to the instant messaging recipient or recipients.

One should note that the instant messaging client software 399, which can be configured to display the user interface of FIG. 4, is included for purposes of illustration, not limitation. As is evident to one of ordinary skill in the art, any instant messaging logic can be used to facilitate communication of instant messages between a user and a recipient.

FIG. 5 is an exemplary display of a second user's instant messaging window, pursuant to the instant messaging software illustrated in FIG. 3. As illustrated, a second user's display can include a “START” option 572, an “INSTANT MESSAGING” taskbar menu item 574, an “EMAIL” taskbar menu item 576, an “INTERNET” taskbar menu item 578, and a Date and Time indicator 580. While these items are similar to the items from the first user's display in FIG. 4, these displays are nonlimiting examples.

Also included in the display of FIG. 5 is an instant messaging window 582, which can include a text prompt 584 and a contact section 586. The contact section can include various instant messaging contacts and presence icons displaying the status of those contacts. In this nonlimiting example “Firstuser” (who is a contact of the second user) is currently not present. While the presence data in FIG. 5 can provide presence information related to the contacts in contact section 586, the information provided is minimal, and the same for all users. One should note that while the term “PRESENCE ICON” is used in this disclosure, as one of ordinary skill in the art will understand, any signifier of presence can be used.

Additionally included in the instant messaging window 582 are a “PRESENCE” option 594, an “OPTIONS . . . ” option 588, a “LOGS . . . ” option 590, and a “SEND” option. The “PRESENCE” option 594 can provide the first user with the ability to determine presence settings, as discussed below. The “OPTIONS . . . ” option 588 can provide the user access to various options related to the display of the instant messaging Window 582, sending options, receiving options, etc. The “CONTACTS” option 590, on the other hand can provide the first user with data related the user's contacts the contacts' presence. The “SEND” option is an action option that executes sending of a message to the recipient or recipients.

FIG. 6 is an exemplary presence window for a first user's instant messaging software, as illustrated in FIG. 3. More specifically, by selecting the “PRESENCE” option 494 from FIG. 4, the first user can be presented with the presence window 682. The presence window 682 can include a “First User's Presence Status” option 688, which can include a plurality of presence statuses that can be determined by the instant messaging server, the instant messaging administrator, or the first user, as described in application Ser. No. ______, attorney docket number 190255.1360 (050273), entitled “Using Statistical Tracking Information Of Instant Messaging Users” filed on Dec. 15, 2005, which is hereby incorporated by reference in its entirety. In this nonlimiting example, the presence statuses created for the first user are “present,” “gone fishing (away),” “in the car (away),” “extended away,” “present, but busy,” and “appointment (away).” As one of ordinary skill in the art will appreciate, other presence statuses can be created or provided for the first user (and other users).

Additionally included in presence window 682 is a “clear” option 692a, which can provide the first user with a way to clear any of the presence statuses listed above. “New” option 692b can provide the first user with the ability to create a new presence status, and “edit” option 692c can provide the first user with a way to edit one or more of the presences listed above.

FIG. 7 is an exemplary specific presence window for a first user's instant messaging software, as illustrated in FIG. 3. As illustrated, the specific presence window 782 can be displayed in response to the first user selecting the “edit” option 692c from FIG. 6. By selecting the “edit” option 692c, the user can be provided with a way to add a customized icon (including an animated icon) for the selected presence status, and a way to add a customizable character sequence for display with this presence status. More specifically, the first user has selected a fishing icon for the presence entitled “gone fishing (away).” This icon is displayed under “icon” display 784. By selecting the “change” option 786, the first user can change the icon displayed for this presence status. Selection of the “change” option 786 can provide the user with a display of possible icons that can be used for the current presence status, can provide the first user with a prompt for locating an image that can be used for the presence icon on client device 106, or can provide the user with the ability to search the Internet for the desired image (or any permutation of these). Additionally some embodiments can provide the first user with the ability to view and utilize presence icons used by other users coupled to the instant messaging server 102.

Additionally, the specific presence window 782 can include a text prompt 788 that can provide the first user with the ability to display any text the first user desires on a contact's instant messaging window. Also included in this nonlimiting example is a “save” option 792 and a “change properties” option 790.

FIG. 8 is an exemplary presence settings window for a first user's instant messaging software, as illustrated in FIG. 3. As illustrated in the presence settings window 882, the first user is provided with the ability to create a new presence based on various criteria in response to selecting the “change properties” option from FIG. 7 (or the “new” option from FIG. 6). More specifically, if the first user desires to create a new presence (or edit an existing presence) the user can access presence settings window 882. The user can select from any of a plurality of criteria for determining when this presence status will be displayed.

As a nonlimiting example, if the first user is typically fishing from 3:00 PM to 4:00 PM, the first user can designate that this particular time is associated with a presence status of “Gone Fishing (Away),” or other user defined presence status. In this scenario, the first user can select “select time range” from the “use when present” option 896.

Similarly, the user can designate that whenever the instant messaging software (or instant messaging server 102) determines that the user is present for only a predetermined percentage of time at a particular time of day, the first user can designate a presence status accordingly. As a nonlimiting example, if the first user selects the <5% option from the “use when present” option 896, the first user can designate this presence status to be “Probably not here, try me at home.” Additionally, the user can designate whether to enable a contact suggestion option 898, which can provide a contact with a suggestion as to where the user may be currently located.

Another option displayed in FIG. 8 is a “message forward option” 892. The “message forward option” 892 can forward a received instant message to the first user when the first user receives a message in the designated presence status. The first user can designate where the instant message is to be forwarded, and in what format the first user desires to receive the forwarded instant message (these options not shown).

As a nonlimiting example, if the first user activates the option to forward messages received when in “Probably not here try me at home” status, the first user can also designate that the message is forwarded to the first user's home email account. The first user can designate that the instant message be attached to an email message. Other embodiments provide that the first user can designate that the message be received as an instant message, as a Short Message Service (SMS) message, as an email message, as a text-to-voice converted voice message, or other type of message (or any permutation of these).

As one of ordinary skill in the art will understand, other options and capabilities may also be available to the first user in creating and managing a presence status. More specifically, the first user can designate a presence status on any of a plurality of different criteria including, but not limited to historical instant messaging usage, time of day, day of week, etc. Additionally, the first user can also customize presence data based on the recipient of the presence data, on the class of the recipients who may receive the data, or any other criteria.

FIG. 9 is an exemplary display of a second user's instant messaging window with a customizable presence icon, pursuant to FIG. 7. As illustrated in the instant messaging window 582, the first user's presence is indicated with the icon associated with the “Gone Fishing (Away)” presence status discussed above. The first user can designate that this presence icon is presented to any instant messaging user who includes the first user as a contact. Other embodiments can also provide the first user with the ability to designate presence statuses and presence icons based on the particular recipient (contact) of the presence information.

FIG. 10 is an exemplary display of a second user's instant messaging window with a user's customizable presence icon, pursuant to FIG. 7. More specifically, the second user has placed a cursor over the “Gone Fishing (Away)” presence icon 986 that is associated with the first user's presence. In response to the placement of the cursor, the instant messaging software 399 associated with the second user's client device 106 can display the text “Be Back at 4:00.” This text 1086 can be associated with the text entered by the first user in text prompt 788, from FIG. 7. Additionally, the title of the presence status can be displayed at the bottom of the instant messaging window 582 upon selection of the user checkbox next to the first user's instant messaging address.

As one of ordinary skill in the art will realize, the first user, second user, or both can determine whether text is displayed with the displayed presence icon. Additionally, while in this nonlimiting example, the text is displayed in one particular format, other formats can also provide the desired information to the second user.

FIG. 11 is an exemplary display of a first user's instant messaging window illustrating a plurality of customizable presence icons, similar to the presence icon from FIG. 10. More specifically, the instant messaging window 482 includes an instant message in text prompt 484 directed to “Leigh.” Leigh is a contact of the first user, and along with the other contacts in contact window 486 Leigh has specified a customized icon related to that Leigh's current presence status. More specifically, Leigh has designated car presence icon 1186a, while Andrew has designated smiley face presence icon 1186b. Louise and Jimmy have both designated house presence icon 1186c and 1186d, but the icons are different. Toby has designated golf presence icon 1186e. As discussed above, each of the users whose contact icons are displayed in FIG. 11 have been provided with the ability to determine the presence icon related to their current presence. Each user can choose (or create) whatever presence signifier they prefer, and are not limited to certain images. Similarly, sounds, animations, themes, and other types of media can also be included with the presence status that may be presented to the first user.

FIG. 12 is an exemplary display of customizable presence icons and customizable text that can be displayed for the icons from FIG. 11. As illustrated, the first user has positioned a cursor over the presence icon related to “Leigh.” Leigh has designated that the text “Presence: Away” 1286 be displayed with the car presence icon. Additionally, although not shown, the title of Leigh's response status can also be displayed. One should also note that similar information can be displayed for the presence icons related to the other contacts displayed in contact window 486. By “hovering,” “double clicking,” or otherwise selecting the first user can be provided with more information related to that contact's presence status.

FIG. 13 is an exemplary display of a presence window for viewing a second user's presence status options, similar to the display from FIG. 6. More specifically, contact presence window 1382 can be displayed to the first user in response to selecting the “CONTACTS” option 492 from FIG. 4 (among others). By selecting the “CONTACTS” option 492, the first user can be provided with a list of the selected contact's presence statuses. “Leigh's Presence Status” option 1388 provides the user with a list of Leigh's presence statuses, which include “Present,” “Presence: Away,” “In the Car (On My Phone),” and “Be Back Tomorrow.”

Also included in the contact's presence window 1382 is an “add” option 1392a and an “edit” option 1392b. The “add” option 1392a can provide the user with the ability to add a presence status for the contact. This new presence can be specific to the first user's instant messaging account (i.e., other instant messaging users will not be provided with this presence), and can provide the first user with more detailed information regarding that particular contact. More specifically, if the first user is aware that Leigh has a class from 4:00 PM to 5:00 PM, the first user can create a presence for Leigh indicating such. Similarly, historical instant messaging usage, such as that described in application Ser. No. ______, attorney docket number 190255.1360 (050273) entitled “Using Statistical Tracking Information Of Instant Messaging Users” filed on Dec. 15, 2005, which is hereby incorporated by reference in its entirety can also be used. Similarly, “edit” option 1392b can provide the first user with the ability to edit one or more of the existing presence statuses.

FIG. 14 is an exemplary override window for overriding the customizable presence icon, such as the icons from FIG. 11. By selecting the “edit” option 1392b from FIG. 13, the first user can be provided with the override window 1482. The override window 1482 can provide the first user with the ability to override any presence data that the contact has provided. More specifically, referring back to FIG. 12, Leigh has designated that a car icon is displayed and that the language “Presence: Away” be displayed. While this information may be helpful, the first user may desire that a different icon be displayed instead (or in addition to) the icon designated by the Leigh. More specifically, in FIG. 14, the first user has designated that the “cash” icon be displayed in “icon” display 1484, and thus be displayed for this presence status for Leigh. By selecting “Override” option 1486, the first user can change the present icon to a desired signifier. Similarly, the first user can change the text that is displayed with the selected presence status for the selected contact by changing the text in text prompt 1488. By selecting the “Save” option 1490, the user can save the present settings.

While the description with reference to FIG. 14 relates to changing a single contact's presence data, this is but a nonlimiting example. Other embodiments can include an option for the first user to change the presence icons for all contacts, certain classes of contacts, etc. Additionally, other embodiments can provide that the first user can override a certain presence status for all contacts, certain contacts, certain classes of contacts, etc.

FIG. 15 is an exemplary display of a first user's instant messaging window illustrating use of the icon from FIG. 14. As illustrated, the first user's display from FIG. 12 is illustrated with the “Cash” icon 1586 included as a presence icon for “Leigh.” Additionally, by hovering the cursor over the presence icon, the first user's instant messaging software can display the text that the user defined in text box 1488 from FIG. 14.

FIG. 16 is a flowchart illustrating exemplary steps that can be taken by instant messaging software for using customizable presence icons, such as the icons from FIG. 11. The first step in the flowchart of FIG. 16 is to receive a request to create new presence data or to edit existing presence data (block 1630). As described above, the first user's instant messaging software 399 can receive a request from the first user to change presence data that is displayed to other users. In response to receiving this request, the first user's instant messaging software 399 can provide an option for the first user to determine the desired presence data (block 1632). Next, the first user's instant messaging software 399 can receive the desired presence data from the first user (block 1634). As described above, the desired presence data can include a presence icon, text, audio, animation, video, or any other data that the first user desires to display for conveying presence information. Next, the instant messaging software can store the received presence data (block 1636).

The next steps in the flowchart of FIG. 16 relate to displaying the received presence data to other users. More specifically, instant messaging software 399 can receive, from a second user, a request for presence data (block 1638). The first user's instant messaging software 399 can supply the presence data via a message initiated by the first user or automatically, without the first user's knowledge. In either event, the first user's instant messaging software 399 can send the requested data (block 1640).

FIG. 17 is a flowchart illustrating exemplary steps that can be taken by a first user's software for sending customizable presence data, such as the presence icons from FIG. 11. The first step in this nonlimiting example is the first user's instant messaging software 399 to receive a request to create new presence data or edit existing presence data (block 1730). Next, the instant messaging software 399 can provide an option for the first user to determine the desired presence data (block 1732). As discussed above, the desired presence data can include static icons, dynamic icons, video, animations, audio, or any permutation of these or other data. Next, the instant messaging software 399 can receive presence data from the user (block 1734). Once the data is received, the instant messaging software 399 can store the desired presence data received from the first user (block 1736). While the flowchart from FIG. 16 illustrates receiving a presence data inquiry from a second user's instant messaging software 399, the flowchart of FIG. 17 illustrates receiving an instant message from a second user, where the message includes a presence data request (block 1738). The difference here is that in block 1738, the second user's instant messaging software 399 sends a presence data request with an instant message initiated by the second user. Upon receiving an instant message from a second user, the first user's instant messaging software 399 also receives a presence data request. The presence data request can include an actual request, or can simply provide information related to when the second user's instant messaging software last received an update of the presence data. If the first user's instant messaging software 399 determines that the first user's presence data has been changed since the second user has received an update, the updated presence data can be sent back to the second user's instant messaging software 399 (block 1740). Finally, the first user's instant messaging software 399 can send a reply message to the received instant message (block 1742).

One should note that in FIG. 17, the presence data can be supplied by the first user's instant messaging software 399 either in a reply instant message from the first user to the second user or automatically upon receiving the presence data request. Additionally, the first user's instant messaging software 399 can send all presence data related to the first user, or only the information that the second user does not have access.

FIG. 18 is a flowchart illustrating exemplary steps that can be taken by instant messaging software for sending customizable presence icons to a server, such as the server 102 from FIG. 1. More specifically, the first step in the flowchart of FIG. 18 is to receive a request to create new presence data or to edit existing presence data (block 1830). Next, the fist user's instant messaging software 399 can provide an option for the first user to determine desired presence data (block 1832). Next, the first user's instant messaging software 399 can receive the first's users presence data from the first user. As stated above, the presence data can include customizable icons, text, graphics, animations, video, audio, or other forms of information that can convey presence.

Next, the first user's instant messaging software can send the presence data to an instant messaging server (block 1836). While the presence data can be maintained by each user's software, the instant messaging server 102 can also maintain the presence data. By having the presence data maintained at a central location, the instant messaging server 102 can streamline the flow of presence data to and from users. More specifically, when a first user changes his or her presence data, this information can automatically be sent to other users, instead of receiving a request from each user for the new data. Further, because the information is centrally located, the presence data can be more efficiently transmitted to the desired recipients. Finally, the first user's instant messaging software can store the presence data (block 1838). Although the presence data is being maintained at the instant messaging server 102, this step can further ensure that the information is always available to the first user.

FIG. 19 is a flowchart illustrating exemplary steps that can be taken by instant messaging software for determining and updating customizable presence icons, such as the icons from FIG. 5. The first step in the flowchart of FIG. 19 is to receive an instant message from a first user where the instant message includes a presence data indicator (block 1930). Next, second user's instant messaging software 399 can determine, based on the received presence data indicator, whether the presence data stored with the second user's instant messaging software 399 is current (block 1932). If the presence data is current, the flowchart can end. If, however, the presence data stored with the second user's instant messaging software 399 is not current, the second user's instant messaging software can request updated presence data from the first user's instant messaging software 399 (block 1934). The second user's instant messaging software 399 can then receive current presence data (block 1936). Next, the second user's instant messaging software can compare the received presence data with the second user's override data (block 1938). The second user's instant messaging software 399 can then store the updated presence data (block 1940).

FIG. 20 is a flowchart illustrating exemplary steps that can be taken by instant messaging software in utilizing customizable presence icons, such as the icons from FIG. 5. The first step in the flowchart of FIG. 20 is for the second user's instant messaging software 399 to log the second user onto the instant messaging server 102 (block 2030). Logging a user onto the instant messaging server 102 can include communicating a userid and userpw, or other authentication process, such as those which utilize biometric technologies. Once the second user is logged onto the instant messaging server 102, the second user's instant messaging software 399 can send a first user presence data indicator and a second user presence data indicator (block 2032). More specifically, the second user's instant messaging software 399 can send an indicator related to his (or her) own presence data and an indicator related to the first user's presence data (and any other contacts of the second user). The presence data indicator can simply include data related to when the second user received the last presence data update. Other forms of indicators can also be used.

Next, the second user's instant messaging software 399 can receive updated presence related to a contact of the second user data (block 2034) from the instant messaging server. The second user's instant messaging software 399 can then compare the received data with the override settings for the second user (block 2036). Finally, the second user's instant messaging software can store the presence data and incorporated override data (block 2038).

FIG. 21 is a flowchart illustrating exemplary steps that can be taken by a server in utilizing customizable presence icons, such as the icons from FIG. 5. The first step in the flowchart of FIG. 21 is for the instant messaging server 102 to log the first user on an instant messaging server (block 2130). As stated above, this can take the form of receiving a USERID and password, biometric authentication, or other form of authentication. Next, the instant messaging server 102 can receive presence data from the first user's instant messaging software 399 (block 2132). Once the information is received, the instant messaging server 102 can compare the received presence data with presence data that has been previously stored (block 2134). If the received presence data is the same as the stored presence data, the “same” branch is followed, and the flowchart ends. If, however, the stored data is different than the received data, the “different” branch is followed, and the instant messaging server 102 can update the stored presence data (block 2136). Additionally, this updated information can be sent to other users for providing presence data for the first user.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method, in an instant messaging environment, comprising:
providing a first instant messaging user with an option to determine at least one instant messaging presence signifier, wherein the at least one instant messaging presence signifier is configured to provide information related to at least one instant messaging presence status related to instant messaging usage of the first instant messaging user;
receiving information related to at least one selected instant messaging presence signifier, wherein the at least one selected instant messaging presence signifier is selected for conveying, to a second instant messaging user, an instant messaging presence status related to instant messaging usage of the first instant messaging user; and
associating the at least one selected instant messaging presence signifier with at least one instant messaging presence status.

2. The method of claim 1, further comprising, in response to a request from the second user for presence information related to the first user, sending the at least one selected presence signifier to the second user.

3. The method of claim 1, further comprising providing an option for the second instant messaging user to override conveyance of the at least one selected instant messaging presence signifier with at least one replacement instant messaging presence signifier, wherein the at least one replacement instant messaging presence signifier can be displayed instead of the selected instant messaging presence signifier.

4. The method of claim 1, wherein the selected presence signifier includes at least one of the following: a static image, a dynamic image, video, an animation, audio, and text.

5. The method of claim 1, further comprising providing the first instant messaging user with an option to determine a text display related to the selected instant messaging presence signifier.

6. The method of claim 1, further comprising providing the first instant messaging user with an option to create a new instant messaging presence status.

7. The method of claim 1, further comprising providing the first instant messaging user with an option to determine to whom the created instant messaging presence signifier is displayed.

8. A computer readable medium that includes a program for an instant messaging environment, the program comprising:
logic configured to provide a first instant messaging user with an option to determine at least one instant messaging presence signifier, wherein the at least one instant messaging presence signifier is configured to provide information related to at least one instant messaging presence status related to instant messaging usage of the first instant messaging user;
logic configured to receive information related to at least one selected instant messaging presence signifier, wherein the at least one selected instant messaging presence signifier is selected for conveying, to a second instant messaging user, an instant messaging presence status related to instant messaging usage of the first instant messaging user; and
logic configured to associate the at least one selected instant messaging presence signifier with at least one instant messaging presence status.

9. The computer readable medium of claim 8, the program further comprising logic configured to, in response to a request from the second user for presence information related to the first user, send the at least one selected presence signifier to the second user.

10. The computer readable medium of claim 8, the program further comprising logic configured to provide an option for the second instant messaging user to override conveyance of the at least one selected instant messaging presence signifier with at least one replacement instant messaging presence signifier, wherein the at least one replacement instant messaging presence signifier can be displayed instead of the selected instant messaging presence signifier.

11. The computer readable medium of claim 8, wherein the selected presence signifier includes at least one of the following: a static image, a dynamic image, video, an animation, audio, and text.

12. The computer readable medium of claim 8, the program further comprising logic configured to provide the first instant messaging user with an option to determine a text display related to the selected instant messaging presence signifier.

13. The computer readable medium of claim 8, the program further comprising logic configured to provide the first instant messaging user with an option to create a new instant messaging presence status.

14. The computer readable medium of claim 8, the program further comprising logic configured to provide the first instant messaging user with an option to determine to whom the created instant messaging presence signifier is displayed.

15. A method for overriding a customizable instant messaging presence signifier, the method comprising:
receiving at least one instant messaging presence signifier associated with a first instant messaging user, wherein the at least one instant messaging presence signifier provides information related to at least one instant messaging presence status related to the first instant messaging user; and
providing an option to a second instant messaging user to determine at least one replacement instant messaging presence signifier for display to the second instant messaging user upon a determination that the first user is currently associated with the at least one instant messaging presence status.

16. The method of claim 15, further comprising displaying the at least one replacement instant messaging presence signifier.

17. The method of claim 15, wherein the at least one replacement instant presence signifier includes at least one of the following: a static image, a dynamic image, video, an animation, audio, and text.

18. The method of claim 15, wherein the at least one instant messaging presence signifier is selected by the first user for conveying presence information related to a predefined presence status.

19. The method of claim 18, wherein the at least one instant messaging presence signifier includes at least one of the following: a static image, a dynamic image, video, an animation, audio, and text.

20. The method of claim 15, further comprising providing the second instant messaging user with an option to determine at least one replacement instant messaging text display associated with the replacement instant messaging presence signifier.
